(19) United States
(12) Patent Application Publication
(10) Pub. No.: US 2026/0302651 A1
(43) Pub. Date: Oct. 1, 2026

(54) COMPOSITE ANTENNA

(71) Applicant: SONY SEMICONDUCTOR SOLUTIONS CORPORATION, KANAGAWA (JP)

(72) Inventor: Masahiro UNO, KANAGAWA (JP)

(21) Appl. No.: 19/474,816

(22) PCT Filed: Apr. 5, 2025
(86) PCT No.: PCT/JP2024/014036

§ 371 Date: Oct. 13, 2025

(30) Foreign Application Priority Data
Apr. 24, 2023 (JP) 2023-070655

(51) Int. Cl. H01Q 21/29; H01Q 9/04; H01Q 9/30; H01Q 13/08

(52) U.S. Cl. CPC H01Q 21/29; H01Q 9/0407; H01Q 9/30; H01Q 13/08

(57) ABSTRACT

A composite antenna includes a dielectric, a ground plane, a first antenna element, and a second antenna element. The ground plane is provided adjacent to the dielectric. The first antenna element is disposed on one surface of the ground plane. The second antenna element is disposed on an opposite surface of the ground plane to the one surface on which the first antenna element is disposed. The ground plane and the first antenna element constitute a first antenna having directivity in a direction parallel to the ground plane, and the ground plane and the second antenna element constitute a second antenna having directivity in a direction vertical to the ground plane.

### TECHNICAL FIELD

The present technology relates to a technology of a composite antenna.

### BACKGROUND ART

A scheme using no satellite electric waves has been proposed for an indoor positioning technology since it is difficult for the indoor positioning technology to receive satellite electric waves. The indoor positioning technology involves, for example, a method of measuring a position of a terminal device owned by a user by establishing wireless communication between the terminal device and an installed apparatus disposed on a predetermined location.

Communication quality is important for the wireless communication performed for this purpose, and a decrease in the communication quality can lead to a decrease in positioning accuracy.

Patent Literature 1 described below discloses a composite antenna apparatus that makes it possible to increase gain while ensuring reception directivity.

### CITATION LIAR

### Patent Literature

Patent Literature 1: Japanese Unexamined Patent Application Publication No. 2002-135046

### SUMMARY OF THE INVENTION

### Problems to be Solved by the Invention

An object of the present technology is to propose a suitable composite antenna applicable to positioning of a terminal device.

### Means for Solving the Problem

A composite antenna according to the present technology includes a dielectric, a ground plane, a first antenna element, and a second antenna element. The ground plane is provided adjacent to the dielectric. The first antenna element is disposed on a surface of the ground plane. The second antenna element is disposed opposite to the first antenna element with respect to the ground plane. The ground plane and the first antenna element constitute a first antenna having directivity in a direction parallel to the ground plane, and the ground plane and the second antenna element constitute a second antenna having directivity in a direction vertical to the ground plane.

It is possible to switch directivity in the wireless communication between the horizontal direction and the vertical direction by making a switch between the first antenna and the second antenna.

### BRIEF DESCRIPTION OF THE DRAWINGS

FIG. 1 is a diagram illustrating an example of an indoor positioning environment.

FIG. 2 is a diagram illustrating a functional configuration of an installed apparatus.

FIG. 3 is a diagram illustrating a configuration example of a communication module.

FIG. 4 is a diagram illustrating a configuration example of a composite antenna according to a first embodiment.

FIG. 5 is a diagram illustrating a configuration and directivity of a first antenna of the composite antenna.

FIG. 6 is a diagram illustrating a configuration and directivity of a second antenna of the composite antenna.

FIG. 7 is a diagram illustrating a configuration example of a composite antenna according to a first modification example of the first embodiment.

FIG. 8 is a diagram illustrating a configuration example of a composite antenna according to a second modification example of the first embodiment.

FIG. 9 is a diagram illustrating a configuration example of a composite antenna according to a third modification example of the first embodiment.

FIG. 10 is a diagram illustrating a configuration example of a composite antenna according to a fourth modification example of the first embodiment.

FIG. 11 is a diagram illustrating a configuration example of a composite antenna according to a fifth modification example of the first embodiment.

FIG. 12 is a perspective view of a configuration example of a composite antenna according to a second embodiment.

FIG. 13 is a side view of the configuration example of the composite antenna according to the second embodiment.

FIG. 14 is a diagram illustrating a configuration example of a composite antenna according to a modification example of the second embodiment.

FIG. 15 is a diagram illustrating a configuration example of a composite antenna according to a third embodiment.

FIG. 16 is a diagram illustrating a configuration example of a composite antenna according to a fourth embodiment.

FIG. 17 is a diagram illustrating a configuration and directivity of a third antenna of the composite antenna.

FIG. 18 is a diagram illustrating a configuration example of a first feeder provided on the same plane as a ground plane.

FIG. 19 is a diagram illustrating a configuration example of a second feeder provided on a surface of a dielectric.

FIG. 20 is a diagram for explaining another antenna applicable to the first antenna and the second antenna.

### MODES FOR CARRYING OUT THE INVENTION

Hereinafter, a description of embodiments will be made in the following order.
<1. Outline>
<2. Configuration of Installed Apparatus>
<3. First Embodiment>
<4. Modification Examples of First Embodiment>
<4-1. First Example>
<4-2. Second Example>
<4-3. Third Example>
<4-4. Fourth Example>
<4-5. Fifth Example>
<5. Second Embodiment>
<6. Modification Example of Second Embodiment>
<7. Third Embodiment>
<8. Fourth Embodiment>
<9. Other Modification Examples>
<10. Conclusion>
<11. Present Technology>

### 1. Outline

A technique for measuring a position of a portable terminal DA owned by a user in a location where satellite electric waves are not receivable, such as an indoor place, necessitates establishing wireless communication between the portable terminal DA and a plurality of installed apparatuses DB installed at an indoor position such as on a ceiling.

The position of the portable terminal DA is measured by establishing the wireless communication between the portable terminal DA and each of the installed apparatuses DB.

The measurement of the position of the portable terminal DA necessitates communication between the installed apparatuses DB to synchronize the installed apparatuses DB with each other and share a result of the positioning. The communication between the installed apparatuses DB may be wired communication; however, wireless communication is preferred in view of efforts and costs for wirings at the time of installation.

Each of the installed apparatuses DB of the present technology establishes wireless communication with both the portable terminal DA and the other installed apparatuses DB.

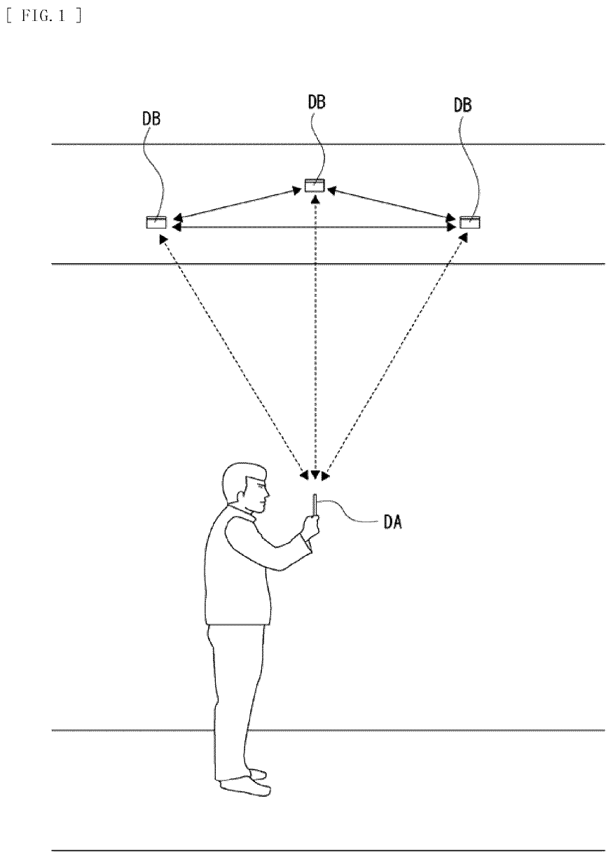

Further, considering an environment in which the position of the portable terminal DA is measured, the portable terminal DA may be present at a position 1 to 2 meters away from a floor, and the installed apparatuses DB are installed in the vicinity of the ceiling, as illustrated in FIG. 1.

In this case, a wireless module included in each of the installed apparatuses DB desirably has an antenna suitable for both the communication with the portable terminal DA (communication indicated by broken lines in FIG. 1) and the communication between the installed apparatuses DB (communication indicated by solid lines in FIG. 1).

This antenna desirably has directivity in a substantially vertical direction for appropriate communication with the portable terminal DA, and also in a substantially horizontal direction for appropriate communication with the other installed apparatuses DB.

Further, in a case where these kinds of communication are performed in an ultra-wide band (UWB), it is important to appropriately design the directivity of the antenna taking into consideration weak electric waves.

### 2. Configuration of Installed Apparatus

A description will be given, with reference to the accompanying drawings, of a configuration of the installed apparatus DB including a composite antenna 1 to which the present technology is applied.

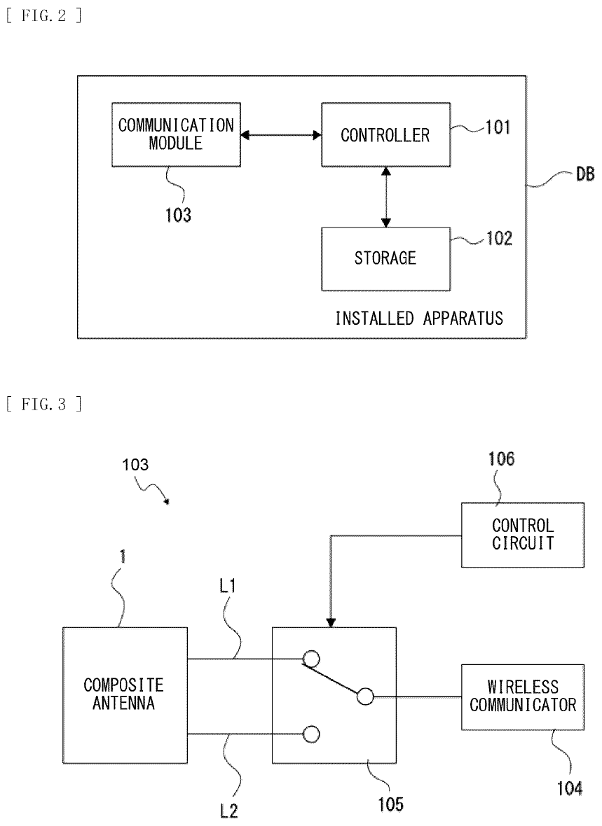

As illustrated in FIG. 2, the installed apparatus DB includes a controller 101, a storage 102, and a communication module 103.

The controller 101 includes, for example, a central processing unit (CPU), a read only memory (ROM), and a random-access memory (RAM). The controller 101 executes various processes in accordance with a program loaded from programs stored in a non-volatile memory such as the ROM or an electrically erasable programmable read-only memory (EEP-ROM) into the RAM. In the RAM of the controller 101, data necessary for the CPU to execute various processes are stored as appropriate.

Examples of the processes to be executed by the controller 101 may include a process of recording a result of the communication with the portable terminal DA, a process of collecting results of the communication with the other installed apparatuses DB, a process of measuring the position of the portable terminal DA based on the collected communication results, and a process of notifying the portable terminal DA of some pieces of information based on the positioning results.

The controller 101 stores the result of communication with the portable terminal DA and the position information on the portable terminal DA in the storage 102.

The communication module 103 includes a plurality of components to establish wireless communication with the portable terminal DA and wireless communication with the other installed apparatuses DB. The communication module 103 establishes the wireless communication in response to an instruction from the controller 101, as appropriate.

FIG. 3 illustrates a configuration example of the communication module 103.

The communication module 103 includes the composite antenna 1 according to the present technology, a wireless communicator 104, a switch element 105, and a control circuit 106.

The wireless communicator 104 has a sending function and a receiving function. Specifically, as components to implement the sending function, the wireless communicator 104 includes, for example, a modulator that performs modulating processing on transmission data, a digital-to-analog converter (DAC) that converts a digital signal received from the modulator into an analog signal, a frequency synthesizer that supplies a local oscillator frequency, and a mixer that converts the local oscillator frequency into a wireless communication transmission frequency by mixing the local oscillator frequency with the signal from the DAC.

As components to implement the receiving function, the wireless communicator 104 includes a low noise amplifier (LNA) that amplifies a radio frequency (RF) signal received from the antenna, a mixer that obtains an I-channel signal and a Q-channel signal by mixing a signal supplied from the LNA with the local oscillator frequency supplied from the frequency synthesizer, a band path filter (BPF) that extracts a signal of a specific frequency band from each of the channel signals obtained by the mixer, a variable gain amplifier (VGA) that adjusts gain of each of the channel signals supplied from the BPF, and an analog-to-digital converter (ADC) that obtains a digital signal.

The switch element 105 includes a switching circuit that switches the antenna to which the wireless communicator 104 is to be coupled.

Two feeders including a first feeder L1 and a second feeder L2 are provided between the switch element 105 and the composite antenna 1. The first feeder L1 and the second feeder L2 are coupled to respective antennas different from each other.

The control circuit 106 switches the antenna to which the wireless communicator 104 is to be coupled, by conducting switching control on the switch element 105.

### 3. First Embodiment

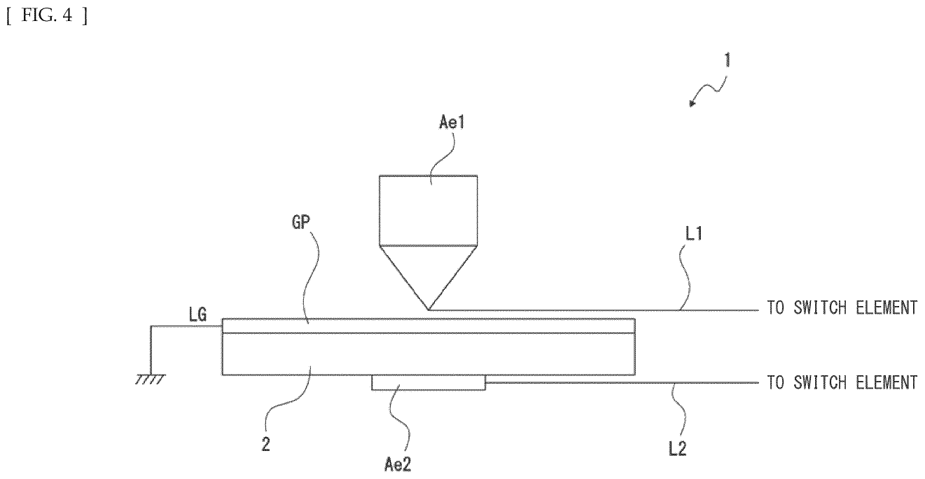

A description will be given of the composite antenna 1 according to a first embodiment to which the present technology is applied. FIG. 4 illustrates a configuration example of the composite antenna 1.

The composite antenna 1 includes a dielectric 2 having a plate shape and provided with a ground plane GP on one surface of the dielectric 2, a first antenna element Ae1 having a rod shape extending vertically, and a second antenna element Ae2 having a square shape extending horizontally.

In the example illustrated in FIG. 4, the first antenna element Ae1 is disposed closer to the surface of the dielectric 2 on which the ground plane GP is provided, and the second antenna element Ae2 is disposed on an opposite surface of the dielectric 2 to the surface on which the first antenna element Ae1 is provided.

In other words, the first antenna element Ae1 and the second antenna element Ae2 are disposed opposed to each other with the ground plane GP interposed therebetween.

When the installed apparatus DB including the composite antenna 1 is installed in the vicinity of the ceiling, the first antenna element Ae1 is disposed above the ground plane GP.

When the installed apparatus DB is installed in the vicinity of the floor, the first antenna element Ae1 is disposed below the ground plane GP.

In the following examples to be described, the installed apparatus DB is installed in the vicinity of a ceiling. That is, the first antenna element Ae1 is disposed above the ground plane GP.

The ground plane GP is grounded via a ground line LG.

The first antenna element Ae1 is insulated from the ground plane GP, and is coupled to the switch element 105 via the first feeder L1.

The second antenna element Ae2 is disposed on the surface of the dielectric 2 opposite to the surface on which the ground plane GP is provided for insulation, and is coupled to the switch element 105 via the second feeder L2.

Power feeding to the first antenna element Ae1 and power feeding to the second antenna element Ae2 are thus switched by switching the switch element 105. This allows the antenna to be used in the wireless communication to be switched.

It is to be noted that, in FIG. 4, the first feeder L1 is disposed separately from the ground plane GP to facilitate understanding; however, the first feeder L1 may be wired on a surface of the ground plane GP in such a manner that the ground plane GP will not cause a short circuit.

Similarly, the second feeder L2 is disposed separately from the dielectric 2; however, the second feeder L2 may be wired on the surface of the dielectric 2.

The first feeder L1 and the second feeder L2 may be disposed in various arrangements. The same applies to the examples described below.

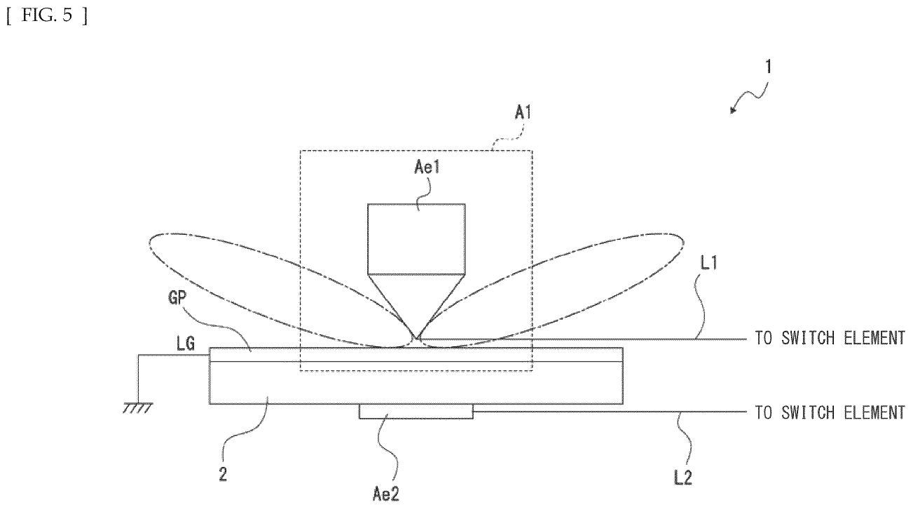

As illustrated in FIG. 5. the first antenna element Ae1 and the ground plane GP serve as a first antenna A1 that is a monocone antenna including a conical portion and a cylindrical portion.

As indicated dash-dotted ellipses in FIG. 5, the first antenna A1 has directivity in a substantially horizontal direction above the ground plane GP. That is, the first antenna A1 is used for the communication between the installed apparatuses DB.

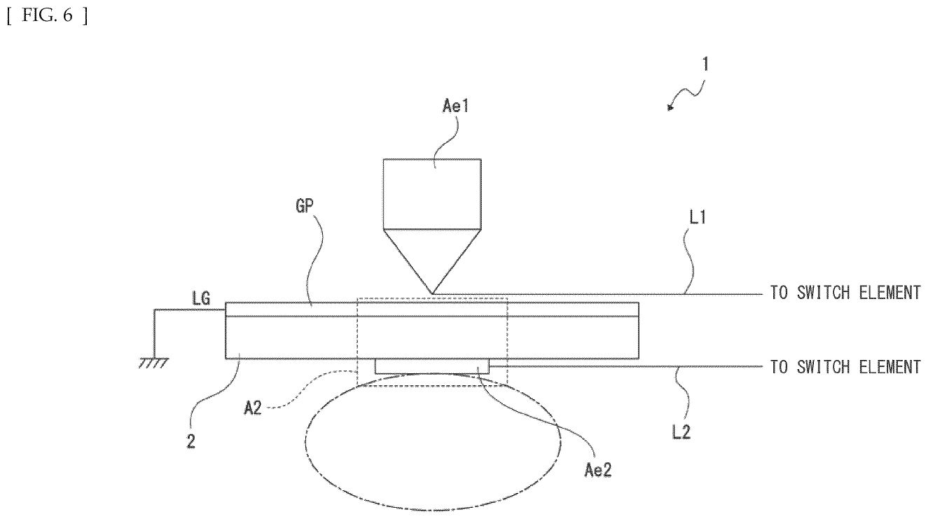

As illustrated in FIG. 6, the second antenna element Ae2 and the ground plane GP serves as a second antenna A2 that is a patch antenna.

As indicated by a dash-dotted ellipse in FIG. 6, the second antenna A2 has directivity in a substantially vertical direction below the ground plane GP. That is, the second antenna A2 is used for the communication between the installed apparatuses DB and the portable terminal DA.

### 4. Modification Examples of First Embodiment

A description will be given of modification examples of the first embodiment.

### 4-1. First Example

In a composite antenna 1A according to a first modification example, the ground plane GP is provided below the dielectric 2.

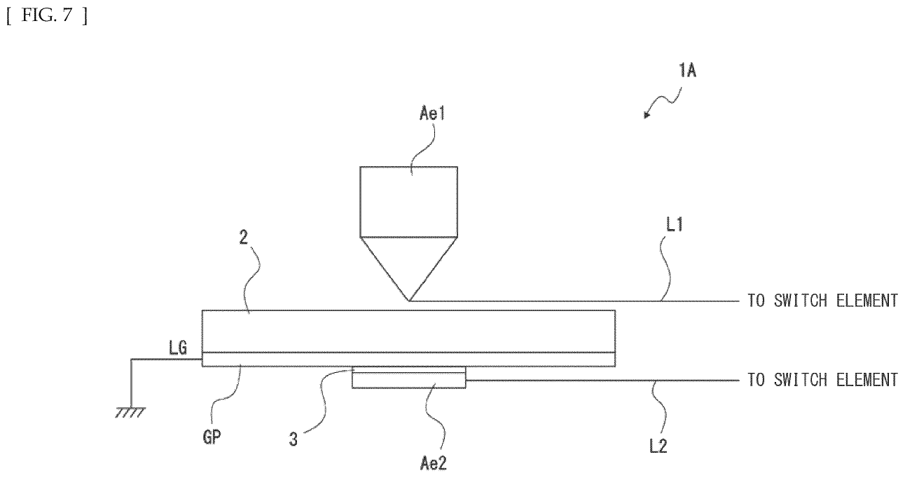

That is, in the composite antenna 1A, the ground plane GP is provided on a lower surface of the dielectric 2, as illustrated in FIG. 7.

The second antenna Ae2 is provided at a substantially center portion of the lower surface of the ground plane GP with an insulator 3 interposed therebetween. The insulator 3 insulates the second antenna element Ae2 from the ground plane GP.

According to the composite antenna 1 of the first embodiment described above, an antenna characteristic of the first antenna A1 is designed to be enhanced by shortening a distance between the first antenna element Ae1 and the ground plane GP.

In contrast, according to the composite antenna 1A of the present modification example, an antenna characteristic of the second antenna A2 is designed to be enhanced by shortening a distance between the second antenna element Ae2 and the ground plane GP.

For example, giving importance to the communication between the installed apparatuses DB or expecting an improvement in the quality of the communication between the installed apparatuses DB, it is preferable to employ the composite antenna 1 according to the first embodiment.

In contrast, giving importance to the communication with the portable terminal DA or expecting an improvement in the quality of the communication with the portable terminal DA, it is preferable to employ the composite antenna 1A according to the present modification example.

### 4-2. Second Example

A composite antenna 1B according to a second modification example is designed to improve the characteristic of the first antenna A1, as compared with the composite antenna 1A according to the first modification example.

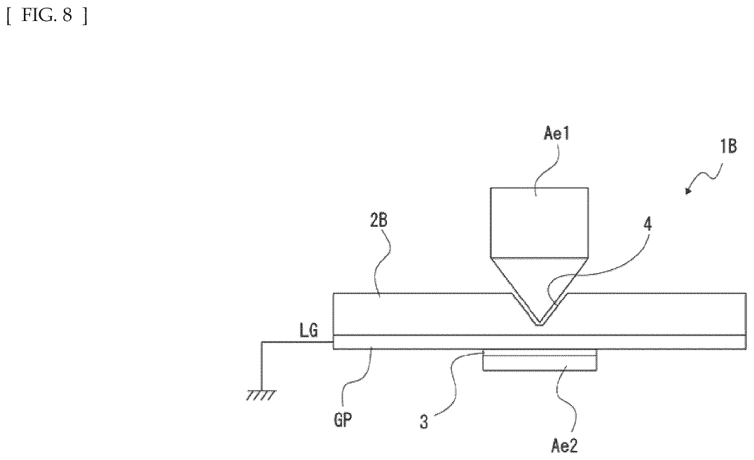

Specifically, as illustrated in FIG. 8, the composite antenna 1B includes a dielectric 2B provided with a first conical recess 4 at a center portion of an upper surface of the dielectric 2B, the first antenna element Ae1 disposed in the first recess 4, the ground plane GP provided on a lower surface of the dielectric 2B, and a second antenna element Ae2 disposed below the ground plane GP with the insulator 3 interposed therebetween.

Further, although not illustrated in the drawings, the first antenna element Ae1 is coupled to the switch element 105 via the first feeder L1, and the second antenna element Ae2 is coupled to the switch element 105 via the second feeder L2.

The ground plane GP is grounded via the ground line LG.

This configuration makes it possible to shorten the distance between the first antenna element Ae1 and the ground plane GP and the distance between the second antenna element Ae2 and the ground plane GP.

It is therefore possible to improve the antenna characteristics of both the first antenna A1 and the second antenna A2.

### 4-3. Third Example

A composite antenna 1C according to a third modification example is designed to improve the antenna characteristics, similarly to the composite antenna 1B according to the second modification example.

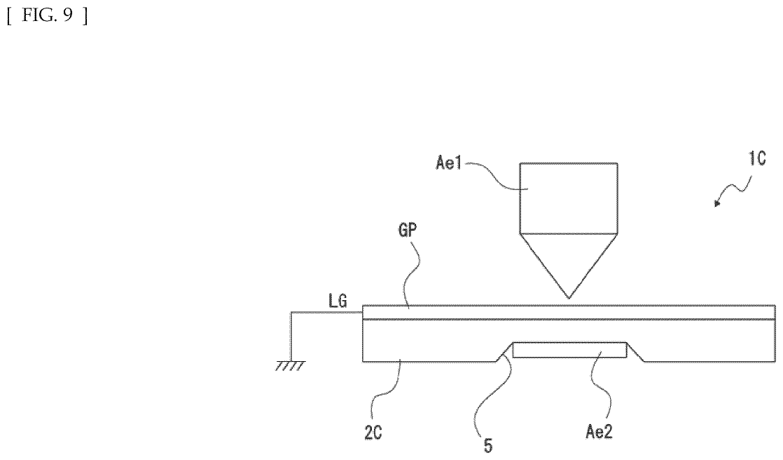

Specifically, as illustrated in FIG. 9, the composite antenna 1C includes a dielectric 2C provided with a second square recess 5 at a center portion of a lower surface of the dielectric 2C, the ground plane GP provided on an upper surface of the dielectric 2C, the first antenna element Ae1 disposed above the ground plane GP in a state of being insulated from the ground plane GP, and the second antenna element Ae2 disposed in the second recess 5.

Further, although not illustrated in the drawings, the first antenna element Ae1 is coupled to the switch element 105 via the first feeder L1, the second antenna element Ae2 is coupled to the switch element 105 via the second feeder L2.

The ground plane GP is grounded via the ground line LG.

This configuration makes it possible to shorten the distance between the first antenna element Ae1 and the ground plane GP and the distance between the second antenna element Ae2 and the ground plane GP, as in the second example.

It is therefore possible to improve the antenna characteristics of both the first antenna A1 and the second antenna A2.

### 4-4. Fourth Example

A composite antenna 1D according to a fourth modification example is designed in consideration of a balance between the characteristic of the first antenna A1 and the characteristic of the second antenna A2.

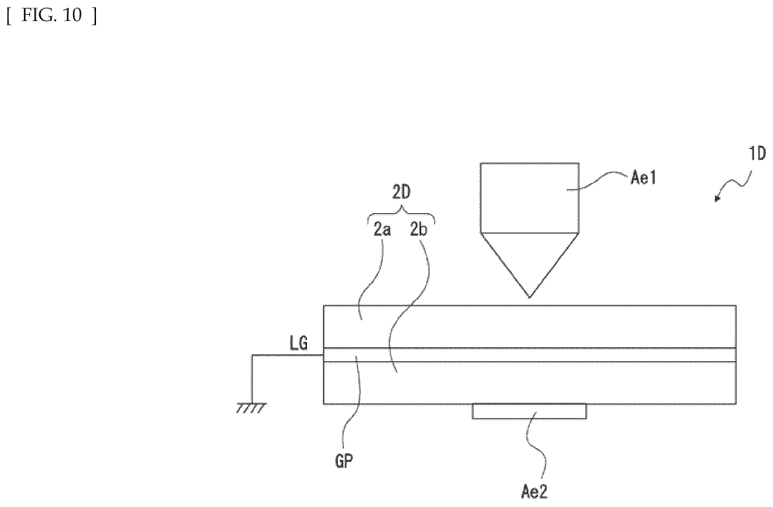

As illustrated in FIG. 10, the composite antenna ID includes a dielectric 2D including a first dielectric layer 2a and a second dielectric layer 2b, the ground plane GP provided between the first dielectric layer 2a and the second dielectric layer 2b, the first antenna element Ae1 disposed above the first dielectric layer 2a, and the second antenna element Ae2 disposed below the second dielectric layer 2b.

Although not illustrated in the drawings, the first antenna element Ae1 is coupled to the switch element 105 via the first feeder L1, and the second antenna element Ae2 is coupled to the switch element 105 via the second feeder L2.

The ground plane GP is grounded via the ground line LG.

The antenna characteristic of the first antenna A1 is variable by changing the thickness of the first dielectric layer 2a. Further, the antenna characteristic of the second antenna A2 is variable by changing the thickness of the second dielectric layer 2b.

Further, the stiffness of the plate-shaped composite antenna 1D is securable by appropriately designing the total thickness of the first dielectric layer 2a and the second dielectric layer 2b.

Further, unlike the composite antenna 1B and the composite antenna 1C, it is unnecessary to provide a recess in the dielectric 2. This facilitates manufacture of the dielectric 2.

It is to be noted that, in the above-described composite antennas 1, 1A, 1B, 1C, and 1D, the ground plane GP is shared between the first antenna A1 and the second antenna A2.

This makes it possible to reduce the size of the composite antenna 1, as compared with a composite antenna including the ground planes GP for respective antennas. Further, taking into consideration the composite antenna 1 having a certain size, sharing the ground plane GP makes it possible to widen the area of the ground plane GP.

### 4-5. Fifth Example

A composite antenna 1E according to a fifth modification example includes the ground planes GP for the respective antennas while securing the size of the ground plane GP similar to that in the above-described examples.

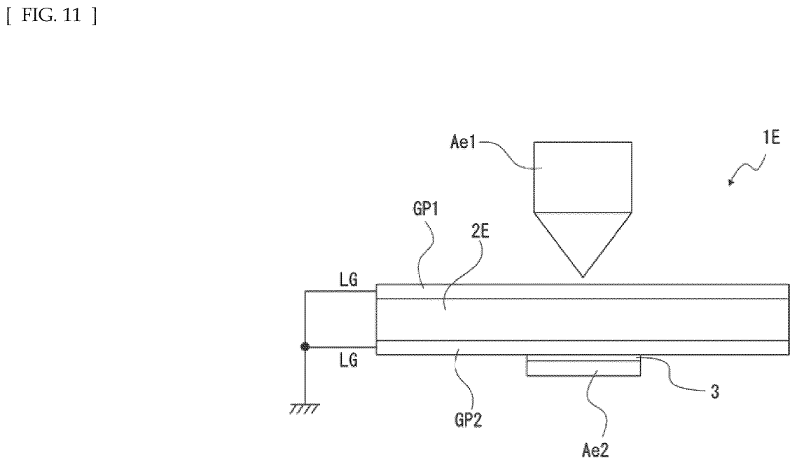

As illustrated in FIG. 11, the composite antenna 1E includes a dielectric 2E, a first ground plane GP1 provided on an upper surface of the dielectric 2E, a second ground plane GP2 provided on a lower surface of the dielectric 2E, the first antenna element Ae1 disposed above the first ground plane GP1, and the second antenna element Ae2 disposed below the second ground plane GP2 via the insulator 3.

Although not illustrated in the drawings, the first antenna element Ae1 is coupled to the switch element 105 via the first feeder L1, and the second antenna element Ae2 is coupled to the switch element 105 via the second feeder L2.

Both the first ground plane GP1 and the second ground plane GP2 are grounded via the ground line LG.

Employing this configuration makes it possible to shorten the distance between the first antenna element Ae1 and the first ground plane GP1 and the distance between the second antenna element Ae2 and the second ground plane GP2.

It is therefore possible to improve the antenna characteristics of the first antenna A1 and the second antenna A2.

It is to be noted that, in the configuration illustrated in FIG. 11, the first ground plane GP1 and the second ground plane GP2 may be further electrically coupled to each other to widen the area of the ground plane GP.

In the case where the first ground plane GP1 is electrically coupled to the second ground plane GP2, a through-hole via provided in the dielectric 2E may be used, for example.

### 5. Second Embodiment

A composite antenna 1F according to a second embodiment includes antenna elements and the switch element 105 coupled to each other via a micro strip line (MSL) provided inside a dielectric 2F as a part of a feeder.

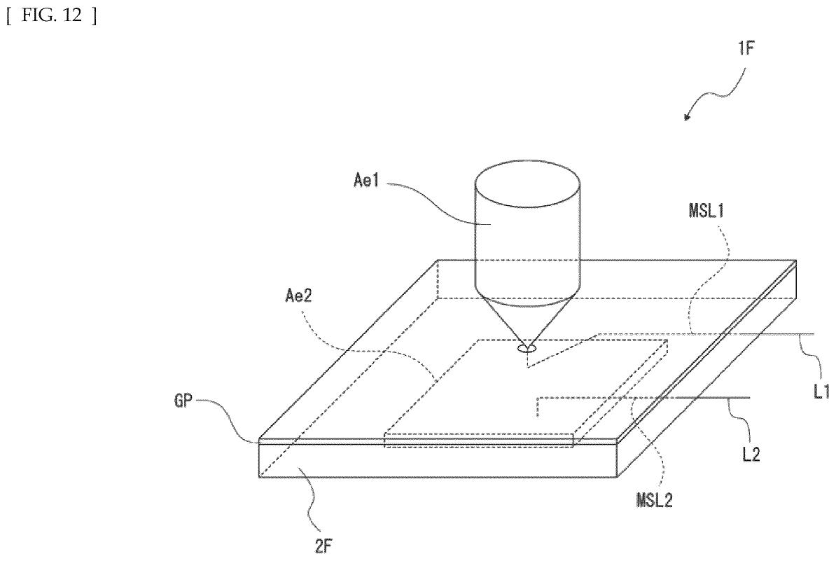

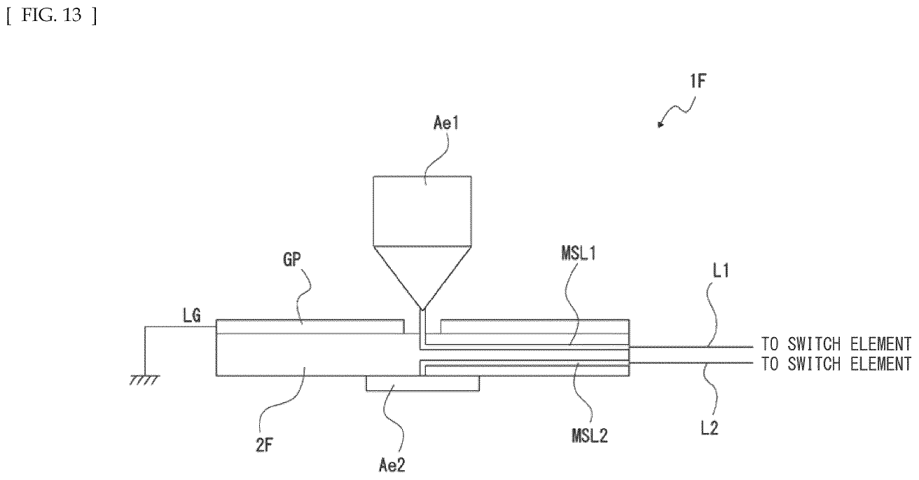

Details are illustrated in FIGS. 12 and 13.

The composite antenna 1F includes the dielectric 2F in which two micro strip lines MSL are provided, the ground plane GP provided on an upper surface of the dielectric 2F, the first antenna element Ae1 disposed above the ground plane GP, and the second antenna element Ae2 disposed below the dielectric 2F.

The ground plane GP1 is provided on the upper surface of the dielectric 2F, excluding a substantially center portion of the upper surface, and a tip of the first antenna element Ae1 is disposed on the center portion.

The two micro strip lines MSL include a first micro strip line MSL1 for the first antenna A1 and a second micro strip line MSL2 for the second antenna A2.

The first micro strip line MSL1 is provided as a part of the first feeder L1, and coupled to the first antenna element Ae1 at one end.

The second micro strip line MSL2 is provided as a part of the second feeder L2, and coupled to the second antenna element Ae2 at one end.

The first micro strip line MSL1 provided inside the dielectric 2F as a part of the first feeder L1 coupling the first antenna element Ae1 and the switch element 105 makes it possible to reduce transmission loss.

The second micro strip line MSL2 provided inside the dielectric 2F as a part of the second feeder L2 coupling the second antenna element Ae2 and the switch element 105 makes it possible to reduce transmission loss.

Further, the first micro strip line MLS1, the second micro strip line MSL2, and the dielectric 2F formable as a single body makes it possible to reduce manufacturing costs.

### 6. Modification Example of Second Embodiment

A modification example of a second embodiment will now be described with reference to the accompanying drawings.

A composite antenna 1G according to the present modification example includes a prepreg layer 6.

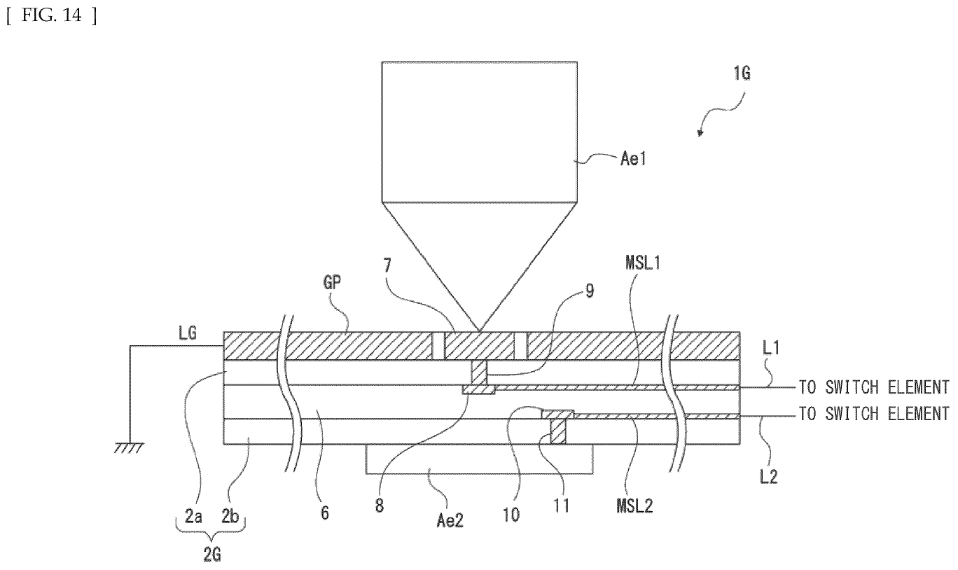

FIG. 14 illustrates a configuration example of the composite antenna 1G.

The composite antenna 1G includes a dielectric 2G including the first dielectric layer 2a and the second dielectric layer 2b, the prepreg layer 6 provided between the first dielectric layer 2a and the second dielectric layer 2b, the ground plane GP grounded by the ground line LG provided on an upper surface of the first dielectric layer 2a, the first antenna element Ae1 disposed above the ground plane GP, and the second antenna element Ae2 disposed below the second dielectric layer 2b.

The ground plane GP is provided on the first dielectric layer 2a excluding a center portion of the first dielectric layer 2a, and a surface land 7 separated from the ground plane GP is provided on the center portion of the upper surface of the first dielectric layer 2a.

One end of the first antenna element Ae1 is mounted on the surface land 7.

An inner land 8 is provided on the lower surface of the first dielectric layer 2a, and the surface land 7 and the inner land 8 are electrically coupled to each other via a blind via 9.

The first micro strip line MSL1 that is a part of the first feeder L1 and coupled to the inner land 8 is provided on the lower surface of the first dielectric layer 2a.

An inner land 10 is provided on the upper surface of the second dielectric layer 2b at a position opposed to the second antenna element Ae2, the inner land 10 and the second antenna element Ae2 are electrically coupled to each other via a blind via 11.

The second micro strip line MSL2 that is a part of the second feeder L2 and coupled to the inner land 10 is provided on the upper surface of the second dielectric layer 2b.

The composite antenna 1G having this configuration may be manufactured by bonding a substrate that is the first dielectric layer 2a having the ground plane GP and the surface land 7 provided on one surface and the inner land 8 and the first micro strip line MSL1 provided on the other surface, to a substrate that is the second dielectric layer 2b having the inner land 10 and the second micro strip line MSL2 provided on one surface and the second antenna element Ae2 on the other surface.

In this case, the prepreg layer 6 is provided as a layer serving as an adhesive material in the composite antenna 1G.

It is to be noted that the first antenna element Ae1 may be mounted on the first dielectric layer 2a before or after bonding the substrates to each other.

### 7. Third Embodiment

A composite antenna 1H according to a third embodiment is provided with a support 12 that supports the first antenna element Ae1 stably.

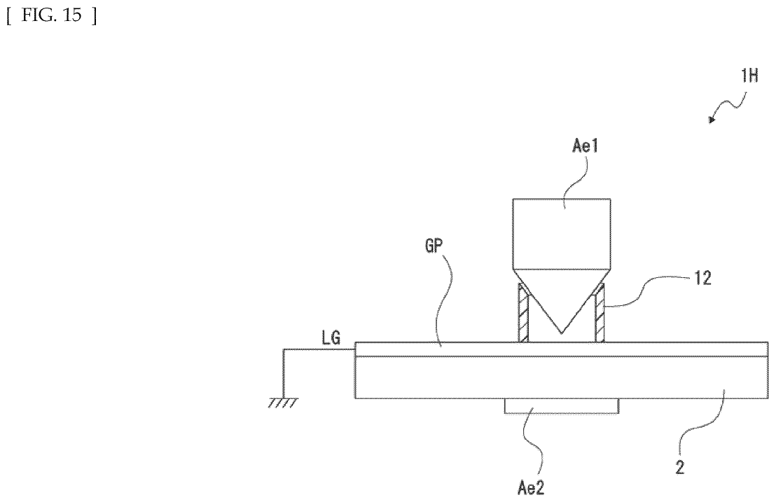

FIG. 15 illustrates an example of the composite antenna 1H.

Similarly to the composite antenna 1 according to the first embodiment, the composite antenna 1H includes the dielectric 2 having a plate shape and provided with the ground plane GP on one surface of the dielectric 2, the first antenna element Ae1 disposed above the ground plane GP, and the second antenna element Ae2 disposed below the dielectric 2.

Further, the composite antenna 1H is provided with the support 12 having a cylindrical shape that supports a tip end of the first antenna element Ae1 and disposed on the ground plane GP.

The tip end of the first antenna element Ae1 is inserted in an inner space of the cylindrical support 12.

It is to be noted that the shape of the support 12 is not limited to this example. The support 12 may be provided in a tubular shape having a cross section other than a circular cross-section. Alternatively, the support 12 may include a plurality of support rods.

As compared with the second antenna element Ae2, the first antenna element Ae1 is prone to be supported unstably. However, providing the support 12 helps to support the first antenna element Ae1 stably.

It is therefore possible to enhance the stiffness of the composite antenna 1H against vibrations and improve durability of the composite antenna 1H.

It is to be noted that, in the present modification example, the composite antenna 1H is made by providing the support 12 to the composite antenna I according to the first embodiment. However, it is to be noted that similar workings and effects may be obtained even when the support 12 is provided in the above-described composite antennas 1 (1A, 1B, 1C, 1D, 1E, 1F, and 1G) other than the composite antenna 1H.

### 8. Fourth Embodiment

A composite antenna 1J according to a fourth embodiment includes a third antenna element Ae3 in addition to the first antenna element Ae1 and the second antenna element Ae2.

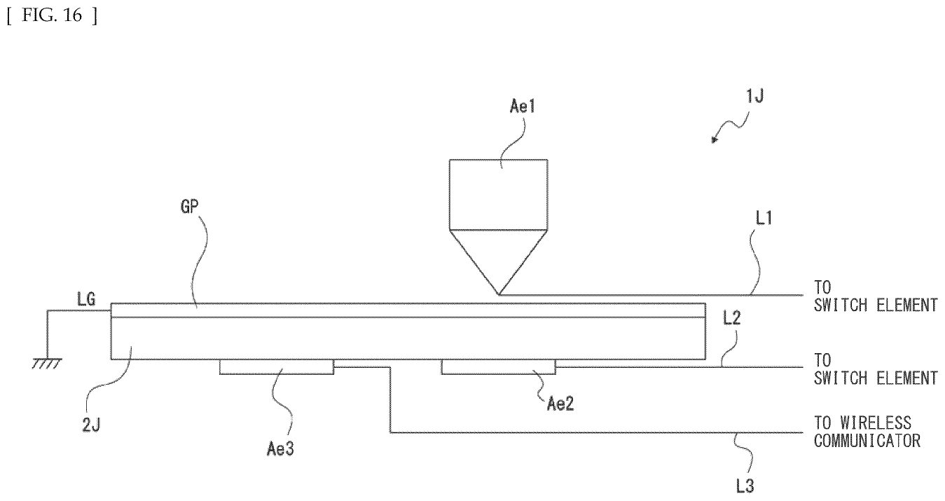

FIG. 16 illustrates an example of the composite antenna 1J.

The composite antenna 1J includes a dielectric 2J, the ground plane GP provided on one surface of the dielectric 2J, the first antenna element Ae1 disposed above the ground plane GP, and the second antenna element Ae2 and the third antenna element Ae3 mounted on another surface of the dielectric 2J.

The ground plane GP is grounded via the ground line LG.

The first antenna element Ae1 is coupled to the switch element 105 via the first feeder L1.

The second antenna element Ae2 is coupled to the switch element 105 via the second feeder L2.

The third antenna element Ae3 is coupled to the wireless communicator 104 via a third feeder L3.

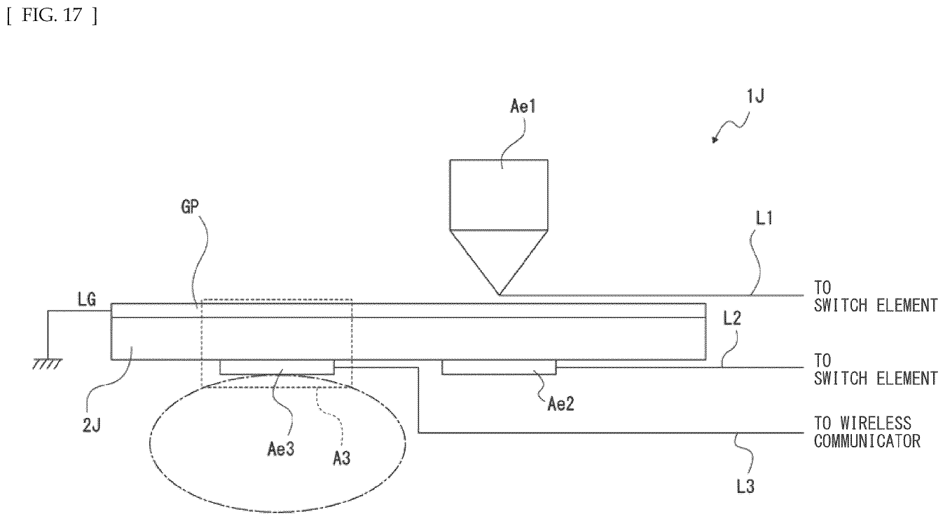

As illustrated in FIG. 17, the third antenna element Ae3 and the ground plane GP serve as a third antenna A3 that is a patch antenna. That is, the third antenna element Ae3 is the same as the second antenna element Ae2 only with a different mounting location.

The second antenna A2 and the third antenna A3 may receive an electric wave from the portable terminal DA at different reception times, depending on the location of the portable terminal DA.

Based on the time difference, the controller 101 of the installed apparatus DB calculates an angle of the electric wave received from the portable terminal DA, i.e., an angle of arrival of the electric wave.

Another method of calculating the angle of arrival may involve outputting electric waves from the second antenna A2 and the third antenna A3 of the installed apparatus DB at the same time, and calculating, with the portable terminal DA, the angle of arrival based on the difference between reception times of the two kinds of electric waves.

That is, the process of calculating the angle of arrival may be performed in the installed apparatus DB based on the angle of arrival (AoA), or may be performed in the portable terminal DA, based on an angle of departure (AoD).

It is to be noted that the composite antenna 1J illustrated in FIGS. 16 and 17 includes the first antenna element Ae1 provided opposed to the second antenna element Ae2; however, this is non-limiting. The first antenna element Ae1 may be provided opposed to the third antenna element Ae3, or may be provided opposed to a portion between the second antenna element Ae2 and the third antenna element Ae3.

Further, the antenna, having the directivity in the vertical direction, of the composite antenna 1J is not limited to the above-described example. Alternatively, three or more antennas may be provided.

The composite antenna 1J including the plurality of antennas having the directivity in the horizontal direction is capable of calculating the angle of arrival of an electric wave. The location of the portable terminal DA is identifiable by calculating the angle of arrival by the plurality of installed apparatuses DB at substantially the same time.

It is therefore possible to identify the location of the portable terminal DA without a synchronization gap between the installed apparatuses DB being limited to a few nanoseconds. That is, it is possible to reduce the communication between the installed apparatuses DB for the synchronization, and reduce a calculation amount and electric power consumption at the installed apparatuses DB.

### 9. Other Modification Examples

In the examples described above, the first antenna A1 and the second antenna A2 perform the time-division communication under the control by the switch element 105.

However, this is non-limiting, and the first antenna A1 and the second antenna A2 may be configured to establish wireless communication at the same time. That is, the composite antenna 1 may not include the switch element 105.

In a case where the second antenna A2 is used as a patch antenna, a plurality of second antenna elements Ae2a and Ae2b may be provided in a thickness direction of the dielectric 2.

This makes it possible to widen the range of the second antenna A2.

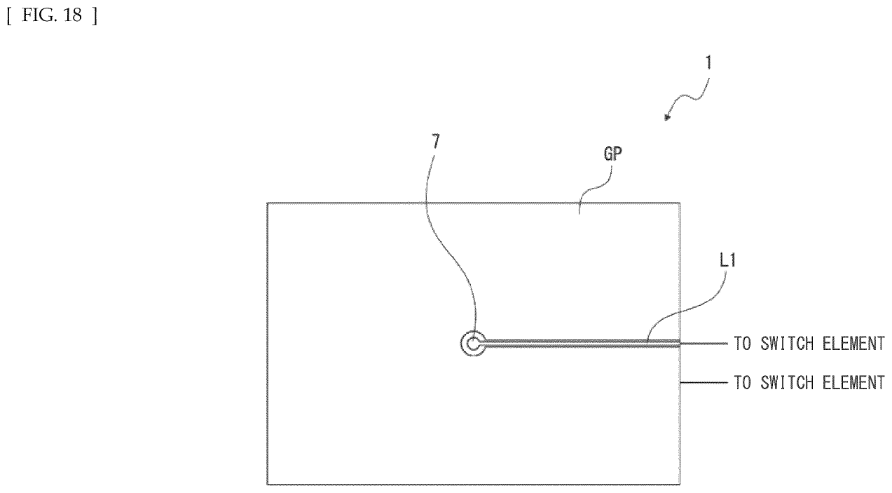

It is to be noted that, in the examples described above, the first feeder L1 may be wired on the surface of the ground plane GP in such a manner that the first feeder L1 and the ground plane GP will not cause a short circuit. A specific example of the wiring manner will now be described with reference to FIG. 18.

It is to be noted that the first antenna element Ae1 is not illustrated in FIG. 18 to facilitate understanding.

The ground plane GP in the composite antenna 1 is provided on one surface of the dielectric 2 excluding a center portion of the dielectric 2, and the surface land 7 separated from the ground plane GP is provided on the center portion of the ground plane GP.

A non-illustrated one end of the first antenna element Ae is mounted on the surface land 7.

The surface land 7 is a feeder provided as a coplanar strip line, and electrically coupled to the switch element 105 via the first feeder L1 provided on the surface of the dielectric 2.

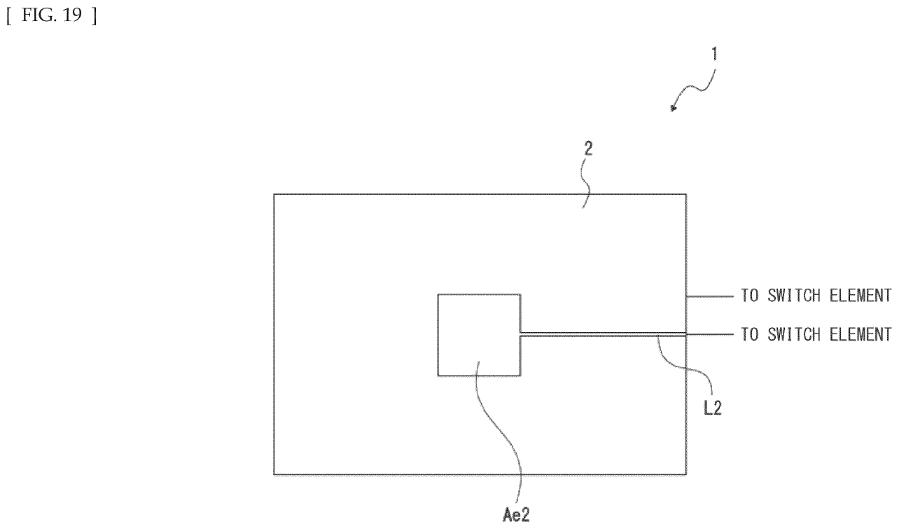

In addition, in the examples described above, the second feeder L2 may be wired on the surface of the dielectric 2. A specific example of the wiring manner will now be described with reference to FIG. 19.

In the dielectric 2 of the composite antenna 1, the second antenna element Ae2 is provided on the opposite surface to the surface on which the ground plane GP is provided.

Further, the second feeder L2, which is, for example, a micro strip line, is provided on the surface of the dielectric 2 on which the second antenna element Ae2 is provided.

The second antenna element Ae2 is electrically coupled to the switch element 105 via the second feeder L2.

In the examples described above, the first antenna A1 is a monocone antenna, and the second antenna A2 is a patch antenna.

However, these are nonlimiting, and various kinds of antennas may be applied as the first antenna A1 and the second antenna A2.

For example, a spherical monopole antenna, a planar monopole antenna, or a linear monopole antenna other than the monocone antenna described above may be employed as the first antenna A1 (refer to FIG. 20).

A circular patch antenna, a helix antenna, or a dielectric antenna other than the square patch antenna may be employed as the second antenna A2 (refer to FIG. 20).

It is to be noted that the third antenna A3 according to the fourth embodiment may be the same antenna as the second antenna A2. That is, a circular patch antenna, a helix antenna, or a dielectric antenna other than the square patch antenna may be employed as the third antenna A3.

### 10. Conclusion

As described in each of the foregoing examples, the composite antenna 1 according to the present technology (1A, 1B, 1C, 1D, 1E, 1F, 1G, 1H or 1J) includes the dielectric 2 (2B, 2C, 2D, 2E, 2F, 2G or 2J), the ground plane GP (GP1 or GP2) provided adjacent to the dielectric 2, the first antenna element Ae1 disposed on the one surface of the ground plane GP, and the second antenna element Ae2 (Ae2a or Ae2b) disposed on the opposite surface of the ground plane GP to the surface on which the first antenna element Ae1 is provided. The ground plane GP and the first antenna element Ae1 constitute the first antenna A1 having directivity in the direction parallel to the ground plane GP, and the ground plane GP and the second antenna element Ae2 constitute the second antenna A2 having directivity in the direction vertical to the ground plane GP.

It is possible to appropriately establish wireless communication in the horizontal direction and the vertical direction by making a switch between the first antenna A1 and the second antenna A2.

Specifically, it is possible to increase a communication distance between the installed apparatuses DB each having the composite antenna 1 by securing the communication quality of the wireless communication in the horizontal direction.

Further, according to the present configuration, the ground plane GP is shared between the first antenna A1 and the second antenna A2.

The composite antenna 1 thus has the directivity in both the direction parallel to the ground plane GP and the direction vertical to the ground plane GP. This makes it possible to achieve space reduction, as compared with the case where both the ground plane GP for the first antenna A1 and the ground plane GP for the second antenna A2 are provided.

Further, under a constraint that the size of the composite antenna 1 should be reduced to a certain size, the area of the shared ground plane GP may be set greater than the area of each of the two ground planes GP provided in the other case.

It is therefore possible to improve the characteristics of the first antenna A1 and the second antenna A2.

As described with reference to the drawings such as FIG. 5, the first antenna A1 in the composite antenna 1 (1A, 1B, 1C, 1D, 1E, 1F, 1G, 1H or 1J) may be a monocone antenna. In this case, the first antenna A1 having directivity in the direction parallel to the ground plane GP (GP1 or GP2) is easily achievable.

As described with reference to the drawings such as FIG. 6, the second antenna A2 in the composite antenna 1 (1A, 1B, 1C, 1D, 1E, 1F, 1G, 1H or 1J) may be a patch antenna. In this case, the second antenna A2 having directivity in the direction vertical to the ground plane GP (GP1 or GP2) is easily achievable.

As illustrated with reference to the drawings such as FIGS. 12, 13, and 14, in the composite antenna 1F, the first feeder L1 that is a feeder supplying a high-frequency signal to the first antenna element Ae1 may be provided inside the dielectric 2F (2G).

This appropriate design of the first feeder L1 makes it possible to reduce a transmission loss of the high-frequency signal to be transmitted from the first feeder L1.

Further, it is possible to form the dielectric 2F (2G) and the first feeder L1 as a single body.

As described with reference to the drawings such as FIG. 18, in the composite antenna 1, the first feeder L1 that is a feeder supplying a high-frequency signal to the first antenna element Ae1 may be provided on the surface of the dielectric 2.

This allows the first feeder L1 to be formed by pattern printing.

As described with reference to the drawings such as FIGS. 12, 13, and 14, in the composite antenna 1F, the second feeder L2 that is a feeder supplying a high-frequency signal to the second antenna element Ae2 may be provided inside the dielectric 2F (2G).

This appropriate design of the second feeder L2 makes it possible to reduce a transmission loss of the high-frequency signal to be transmitted from the second feeder L2.

Further, it is possible to form the dielectric 2F (2G) and the second feeder L2 as a single body.

As illustrated with reference to the drawings such as FIG. 19, in the composite antenna 1, the second feeder L2 that is a feeder supplying a high-frequency signal to the second antenna element Ae2 may be provided on the surface of the dielectric 2.

This allows the second feeder L2 to be formed by pattern printing.

As described with reference to the drawings such as FIG. 14, in the composite antenna 1G, the dielectric 2G may be a stack of the first dielectric layer 2a, the second dielectric layer 2b, and the prepreg layer 6. The first dielectric layer 2a is an outermost layer closer to the first antenna element Ae1. The second dielectric layer 2b is an outermost layer closer to the second antenna element Ae2. The prepreg layer 6 is provided between the first dielectric layer 2a and the second dielectric layer 2b. The feeder may be provided at a location on the first dielectric layer 2a closer to the prepreg layer 6.

It is therefore possible to easily form the dielectric 2G by bonding the first dielectric layer 2a including the ground plane GP on one surface and the feeder provided on the other surface, to the second dielectric layer 2b including the second antenna element Ae2 provided on one surface.

As illustrated with reference to the drawings such as FIG. 14, in the composite antenna 1G, the surface land 7 may be provided on the surface of the first dielectric layer 2a on which the first antenna element Ae1 is provided, and the inner land 8 is provided on the surface of the first dielectric layer 2a opposite to the surface on which the first antenna element Ae1 is provided. The surface land 7 and the inner land 8 may be electrically coupled to each other via the blind via 9. The surface land 7 may be electrically coupled to the first antenna element Ae1, and the inner land 8 may be electrically coupled to the first feeder L1.

This allows the first antenna element Ae1 provided outside the dielectric layer via the blind via 9 and the first feeder L1 provided inside the dielectric layer to be electrically coupled to each other.

It is therefore possible to manufacture the composite antenna 1 without a complicated process.

As described with reference to the drawings such as FIG. 15, the composite antenna 1H may include the support 12 that includes an insulating member and supports the first antenna element Ae1.

This allows the first antenna element Ae1 to be stably supported by the dielectric 2H and the ground plane GP, and appropriately prevents the first antenna element Ae1 from falling off or the like.

As described with reference to the drawings such as FIGS. 16 and 17, the composite antenna 1J may include the third antenna element Ae3 provided on the same surface of the ground plane GP (GP1, GP2) on which the second antenna element Ae2 is disposed, and the ground plane GP and the third antenna element Ae3 may constitute the third antenna A3 having directivity in the direction vertical to the ground plane GP.

For example, the third antenna A3 is a patch antenna similarly to the second antenna A2, This allows the second antenna A2 and the third antenna A3 to calculate the angle of arrival of an electric wave.

It is therefore possible to measure the location of a target communication device (portable terminal DA) using the plurality of composite antennas 1.

As described with reference to the drawings such as FIG. 3, the composite antenna 1 (1A, 1B, 1C, 1D, 1E, 1F, 1G, 1H, or 1J) may include the first feeder L1 that supplies a high-frequency signal to the first antenna element Ae1, the second feeder L2 that supplies a high-frequency signal to the second antenna element Ae2, the wireless communicator 104 that generates a high-frequency signal, and the switch element 105 that switches coupling of the first feeder L1 and the second feeder L2 with respect to the wireless communicator 104.

It is therefore possible to switch the antenna to be used between when the communication is made with the communication device (installed apparatus DB) located in the direction parallel to the ground plane GP (GP1 or GP2) and when the communication is made with the communication device (portable terminal DA) located in the direction vertical to the ground plane GP.

As described with reference to the drawings such as FIG. 3, the composite antenna 1 (1A, 1B, 1C, 1D, 1E, 1F, 1G, 1H or 1J) may include the controller 101 that controls the switch element 105.

This makes it possible to switch the antenna appropriately based on a predetermined program, which is suitable to the case where the antenna is to be switched based on the location of the target communication device.

In particular, in a case where the installed apparatuses DB each including the composite antenna 1 is disposed in an upper space such as on a ceiling, it is possible to control the switch element 105 to use the first antenna A1 for the communication between the installed apparatuses DB, and use the second antenna A2 for the communication with the portable terminal DA owned by the user. It is therefore possible to establish appropriate communication in accordance with the target communication device.

It is to be noted that the effect described herein are mere examples and non-limiting, and other effects may be provided.

The examples described above may be combined in any way, and the workings and effects described above may be obtained even when various combination are made.

### 11. Present Technology

The present technology may have the following configurations.
(1) A composite antenna including:
   a dielectric;
   a ground plane provided adjacent to the dielectric;
   a first antenna element disposed on one surface of the ground plane; and
   a second antenna element disposed on an opposite surface of the ground plane to the one surface on which the first antenna element is disposed, in which
   the ground plane and the first antenna element constitute a first antenna having directivity in a direction parallel to the ground plane, and
   the ground plane and the second antenna element constitute a second antenna having directivity in a direction vertical to the ground plane.
(2) The composite antenna according to (1), in which the first antenna is a monopole antenna.
(3) The composite antenna according to (1) or (2), in which the second antenna is a patch antenna.
(4) The composite antenna according to any one of (1) to (3), in which a first feeder that is a feeder supplying a high-frequency signal to the first antenna element is provided inside the dielectric.
(5) The composite antenna according to any one of (1) to (3), in which a first feeder that is a feeder supplying a high-frequency signal to the first antenna element is provided on a surface of the dielectric.
(6) The composite antenna according to any one of (1) to (5), in which a second feeder that is a feeder supplying a high-frequency signal to the second antenna element is provided inside the dielectric.
(7) The composite antenna according to any one of (1) to (5), in which a second feeder that is a feeder supplying a high-frequency signal to the second antenna element is provided on a surface of the dielectric.
(8) The composite antenna according to (4) or (6), in which
   the dielectric is a stack of a first dielectric layer, a second dielectric layer, and a prepreg layer, the first dielectric layer being an outermost layer closer to the first antenna element, the second dielectric layer being an outermost layer closer to the second antenna element, the prepreg layer being provided between the first dielectric layer and the second dielectric layer, and
   the feeder is provided at a location on the first dielectric layer closer to the prepreg layer.
(9) The composite antenna according to (8), in which
   a surface land is provided on a surface of the first dielectric layer on which the first antenna element is provided, and an inner land is provided on an opposite surface of the first dielectric layer to the surface on which the first antenna element is disposed,
   the surface land and the inner land are electrically coupled to each other via a blind via,
   the surface land is electrically coupled to the first antenna element, and
   the inner land is electrically coupled to the first feeder.
(10) The composite antenna according to any one of (1) to (9), including
   a support including an insulating member and supporting the first antenna element.
(11) The composite antenna according to any one of (1) to (10), including
   a third antenna element disposed on the opposite surface of the ground plane on which the second antenna element is disposed, in which
   the ground plane and the third antenna element constitute a third antenna having directivity in the direction vertical to the ground plane.
(12) The composite antenna according to any one of (1) to (11), including:
a first feeder supplying a high-frequency signal to the first antenna element;
   a second feeder supplying a high-frequency signal to the second antenna element;
   a wireless communicator generating a high-frequency signal; and
   a switch element switching coupling of the first feeder and the second feeder with respect to the wireless communicator.
(13) The composite antenna according to (12), including a controller controlling the switch element.

### REFERENCE SIGN LIST

1, 1A, 1B, 1C, 1D, 1E, 1F, 1G, 1H, 1J: composite antenna
2, 2B, 2C, 2D, 2E, 2F, 2G, 2J: dielectric
2a: first dielectric layer
2b: second dielectric layer
6: prepreg layer
7: surface land
8: inner land
9: blind via
12: support
101: controller
104: wireless communicator
105: switch element
L1: first feeder
L2: second feeder
GP: ground plane
GP1: first ground plane
GP2: second ground plane
Ae1: first antenna element
Ae2, Ae2a, Ae2b: second antenna element
Ae3: third antenna element
A1: first antenna
A2: second antenna
A3: third antenna

What is claimed is:

1. A composite antenna comprising:
a dielectric;
a ground plane provided adjacent to the dielectric;
a first antenna element disposed on one surface of the ground plane; and
a second antenna element disposed on an opposite surface of the ground plane to the one surface on which the first antenna element is disposed, wherein
the ground plane and the first antenna element constitute a first antenna having directivity in a direction parallel to the ground plane, and
the ground plane and the second antenna element constitute a second antenna having directivity in a direction vertical to the ground plane.

2. The composite antenna according to claim 1, wherein the first antenna comprises a monopole antenna.

3. The composite antenna according to claim 1, wherein the second antenna comprises a patch antenna.

4. The composite antenna according to claim 1, wherein a first feeder that is a feeder supplying a high-frequency signal to the first antenna element is provided inside the dielectric.

5. The composite antenna according to claim 1, wherein a first feeder that is a feeder supplying a high-frequency signal to the first antenna element is provided on a surface of the dielectric.

6. The composite antenna according to claim 1, wherein a second feeder that is a feeder supplying a high-frequency signal to the second antenna element is provided inside the dielectric.

7. The composite antenna according to claim 1, wherein a second feeder that is a feeder supplying a high-frequency signal to the second antenna element is provided on a surface of the dielectric.

8. The composite antenna according to claim 4, wherein
the dielectric comprises a stack of a first dielectric layer, a second dielectric layer, and a prepreg layer, the first dielectric layer comprising an outermost layer closer to the first antenna element, the second dielectric layer comprising an outermost layer closer to the second antenna element, the prepreg layer being provided between the first dielectric layer and the second dielectric layer, and
the feeder is provided at a location on the first dielectric layer closer to the prepreg layer.

9. The composite antenna according to claim 8, wherein
a surface land is provided on a surface of the first dielectric layer on which the first antenna element is provided, and an inner land is provided on an opposite surface of the first dielectric layer to the surface on which the first antenna clement is disposed,
the surface land and the inner land are electrically coupled to each other via a blind via,
the surface land is electrically coupled to the first antenna element, and
the inner land is electrically coupled to the first feeder.

10. The composite antenna according to claim 1, comprising
a support including an insulating member and supporting the first antenna element.

11. The composite antenna according to claim 1, comprising
a third antenna element disposed on the opposite surface of the ground plane on which the second antenna element is disposed, wherein
the ground plane and the third antenna element constitute a third antenna having directivity in the direction vertical to the ground plane.

12. The composite antenna according to claim 1, comprising:
a first feeder supplying a high-frequency signal to the first antenna element;
a second feeder supplying a high-frequency signal to the second antenna element;
a wireless communicator generating a high-frequency signal; and
a switch element switching coupling of the first feeder and the second feeder with respect to the wireless communicator.

13. The composite antenna according to claim 12, comprising a controller controlling the switch element.
